(19) United States
(12) Patent Application Publication
(10) Pub. No.: US 2002/0158047 A1
(43) Pub. Date: Oct. 31, 2002

(54) Formation of an optical component having smooth sidewalls

(76) Inventor: Yiqiong Wang, San Marino, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 10/072,811

(22) Filed: Feb. 8, 2002

Related U.S. Application Data
(63) Continuation-in-part of application No. 09/845,093, filed on Apr. 27, 2001.

(51) Int. Cl. B29D 11/00

(52) U.S. Cl. 216/24

(57) ABSTRACT

The invention relates to a method of forming an optical component having a light transmitting medium positioned over a base. The method includes forming a mask over the light transmitting medium. The mask is formed so as to protect a region of the light transmitting region where a waveguide is to be formed. The method also includes applying an etching medium to the light transmitting medium so as to form one or more surfaces of the waveguide. The etching medium includes a fluorine containing gas and one or more partial passivants. In some instances, the etching medium excludes oxygen.

### RELATED APPLICATIONS

This application is a continuation-in-part of U.S. patent application Ser. No. 09/845,093 filed on Apr. 30, 2001 entitled “Formation of an Optical Component Having Smooth Sidewalls” and incorporated herein in its entirety.

### BACKGROUND

1. Field of the Invention

The invention relates to formation of optical components. In particular, the invention relates to formation of smooth surfaces on optical components.

2. Background of the Invention

A variety of optical networking components include one or more waveguides for carrying of light signals. These waveguides are often defined by one or more surfaces. Examples of these surfaces include waveguide sidewalls and facets. These surfaces can cause scattering of the light signals traveling along the waveguide, entering the waveguide through a facet and/or exiting the waveguide through a facet. This scattering is often a source of optical loss and/or cross talk and can adversely affect the performance of the optical component.

The amount of scattering at a surface increases as the roughness of the surface increases. The sidewalls of a waveguide are often formed by etching an optical component according to the Bosch process. The Bosch process employs alternating application of a passivant and an etchant. The alternating steps of the Bosch process result in sidewalls with an undesirably high level of roughness.

For the above reasons, there is a need for an improved method of forming surfaces on an optical component.

### SUMMARY OF THE INVENTION

The invention relates to a method of forming an optical component having a light transmitting medium positioned over a base. The method includes forming a mask over the light transmitting medium. The mask is formed so as to protect a region of the light transmitting region where a waveguide is to be formed. The method also includes applying an etching medium to the light transmitting medium so as to form one or more surfaces of the waveguide. The etching medium includes a fluorine containing gas and one or more partial passivants.

Another embodiment of the method includes obtaining an optical component having a light transmitting medium positioned over a base. The method also includes applying an etching medium to the light transmitting medium so as to form at least one surface of a waveguide in the light transmitting medium. The etching medium includes a fluorine containing gas and one or more partial passivants.

In some instances, the surface of the waveguide is a sidewall of the waveguide and/or a waveguide facet.

The fluorine containing gas can be selected from a group consisting of SF₆, Si₂F₆, CF₄, and NF₃. The partial passivant can be selected from a group consisting of HBr, C₄F₈, CH₂F₂, SiF₄ or CHF₃. One embodiment of the etching medium includes SF₆ as the fluorine containing gas and CHF₃ as the partial passivant. Another embodiment of the etching medium includes SF₆ as the fluorine containing gas and C₄F₈ as the partial passivant. In some instances, the etching medium includes oxygen and in some instances, the etching medium excludes oxygen. In one embodiment of the invention, the etching medium is applied in an inductively coupled plasma etcher.

In another embodiment of the invention, the etching medium is applied at a chamber pressure of 1 mTorr to 600 mTorr, 1 mTorr to 200 mTorr, 1 mTorr to 60 mTorr, 1 mTorr to 30 mTorr or 10 mTorr to 20 mTorr.

The etching medium can have a molar ratio of partial passivant to fluorine containing gas less than 100:1, 50:1, 10:1, 5:1 or 2:1. In some instances, the molar ratio of the partial passivant to the fluorine containing gas is in the range of 0.1:1 to 100:1, 0.5:1 to 10:1 or 1:1 to 2:1.

The etching medium can include other components. In one embodiment, the etching medium includes a second fluorine containing gas selected from the group consisting of SiF₄ and SiF₆. In another embodiment, the etching medium includes a noble gas.

### BRIEF DESCRIPTION OF THE FIGURES

FIG. 1A is a topview of an optical component formed according to the present invention. The optical component includes a light transmitting medium over a base.

FIG. 1B is a cross section of the optical component taken at the line labeled A in FIG. 1A.

FIG. 1C is a sideview of the optical component taken looking in the direction of the arrow labeled B in FIG. 1A.

FIG. 1D illustrates an optical component having a cladding layer formed over the light transmitting medium.

FIG. 1E is a perspective view of an optical component having a reflecting surface positioned so as to reflect light signals from one waveguide into another waveguide.

FIG. 2A through FIG. 2J illustrate a method of forming an optical component having surfaces that define a waveguide.

FIG. 2K illustrates an optical component having a plurality of waveguides formed according to the method of FIG. 2A through FIG. 2J.

### DETAILED DESCRIPTION OF THE PREFERRED EMBODIMENT

The invention relates to a method of forming the surfaces of waveguides on an optical component. The method includes forming a mask over the light transmitting medium. The mask is formed so as to protect a region of the light transmitting region where a waveguide is to be formed. The method also includes applying an etching medium to the light transmitting medium so as to form one or more surfaces of the waveguide.

Etching mediums that include a fluorine containing gas and a partial passivant can provide the surfaces of the waveguide with the desired level of smoothness. In some instances, the etching medium is applied at a pressure of 1 mTorr to 600 mTorr, 1 mTorr to 200 mTorr, 1 mTorr to 60 mTorr, 1 mTorr to 30 mTorr or 10 mTorr to 20 mTorr. When the etching medium is applied in a directional etch, lower pressures can provide additional smoothness by allowing the degree of directionality to be increased.

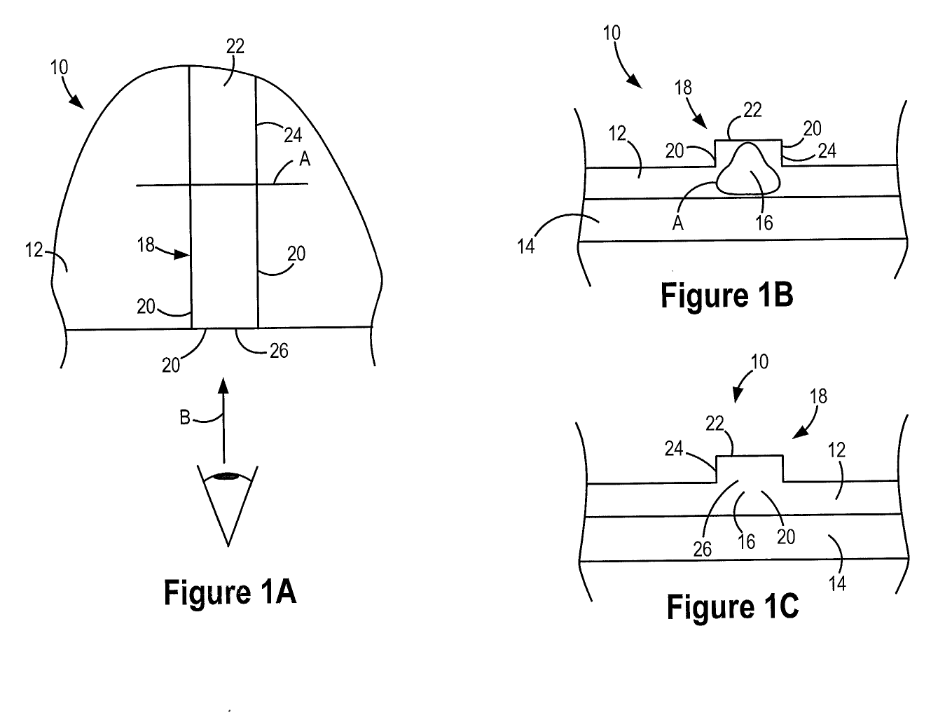

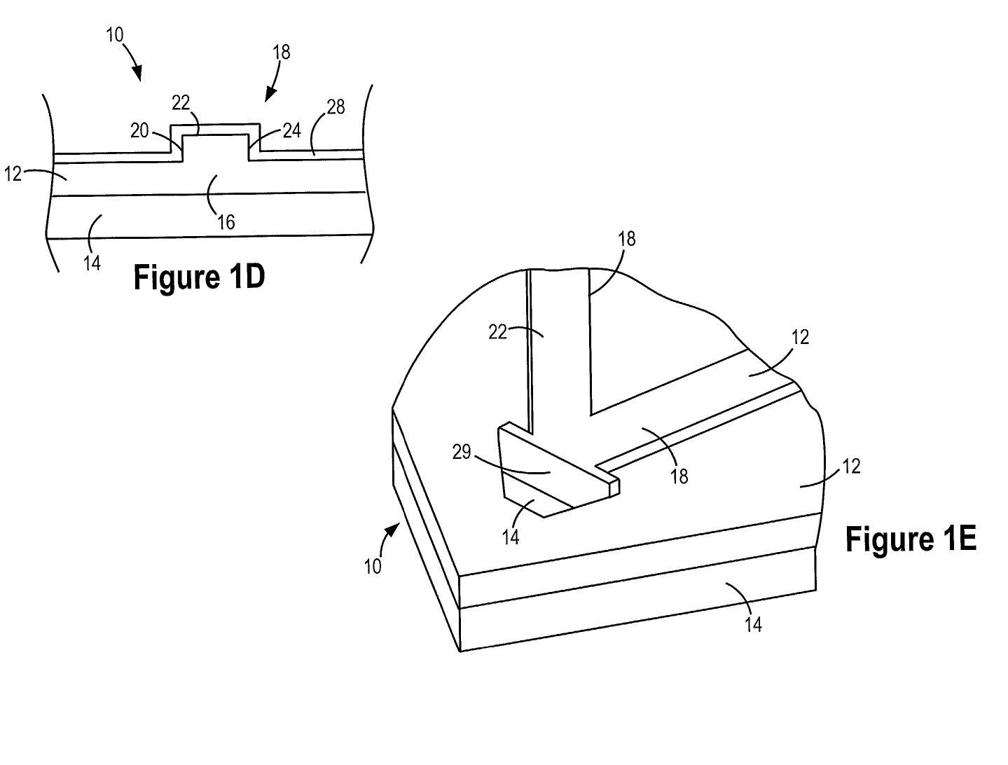

FIG. 1A is a topview of an optical component 10. FIG. 1B is a cross section of the optical component 10 taken at the line labeled A. FIG. 1C is a sideview of the optical component 10 taken looking in the direction of the arrow labeled B.

The optical component 10 includes a light transmitting medium 12 positioned over a base 14. A suitable light transmitting medium 12 includes, but is not limited to, silicon. A waveguide having a light signal carrying region 16 is defined in the light transmitting medium 12. The line labeled A illustrates the profile of a light signal carried in the light signal carrying region 16.

A ridge 18 defines a portion of the light signal carrying region 16. The ridge 18 is defined by a plurality of surfaces 20 including a top 22 and sidewalls 24. These surfaces 20 reflect light signals from the light signal carrying region 16 back into the light signal carrying region 16. Accordingly, these surfaces 20 define a portion of the light signal carrying region 16. The light signal can also be scattered by these surfaces 20. Increasing the smoothness of these surfaces 20 can reduce the amount of scattering.

The portion of the base 14 under the ridge 18 includes a material that reflects light signals from the light signal carrying region 16 back into the light signal carrying region 16. As a result, the base 14 also defines a portion of the light signal carrying region 16.

The waveguide ends at a waveguide facet 26 through which light signals enter and/or exit from the optical component 10. The waveguide facet 26 is often coupled with an optical fiber to carry light signals to and/or from the optical component 10. The waveguide facet 26 is also a surface 20 where undesirable scattering of light signals can occur. Increasing the smoothness of the waveguide facet 26 can reduce the amount of scattering.

A cladding layer 28 can optionally be formed over the light transmitting medium 12 as shown in FIG. 1D. When the light transmitting medium 12 is silicon, a suitable cladding layer 28 is silica. Although a cladding layer 28 is shown, other layers such as protective layers can be positioned over the waveguide.

FIG. 1E illustrates an optical component including a reflecting surface 29 positioned at the intersection of a plurality of waveguides. The reflecting surface 29 is configured to reflect light signals from one waveguide into the other waveguide. The reflecting surface 29 extends below the base of the ridge. For instance, the reflecting surface 29 can extend through the light transmitting medium to the base and in some instances can extend into the base. The reflecting surface 29 extends to the base because the light signal carrying region is positioned in the ridge as well as below the ridge as shown in FIG. 1B. As result, extending the reflecting surface 29 below the base of the ridge increases the portion of the light signal that is reflected.

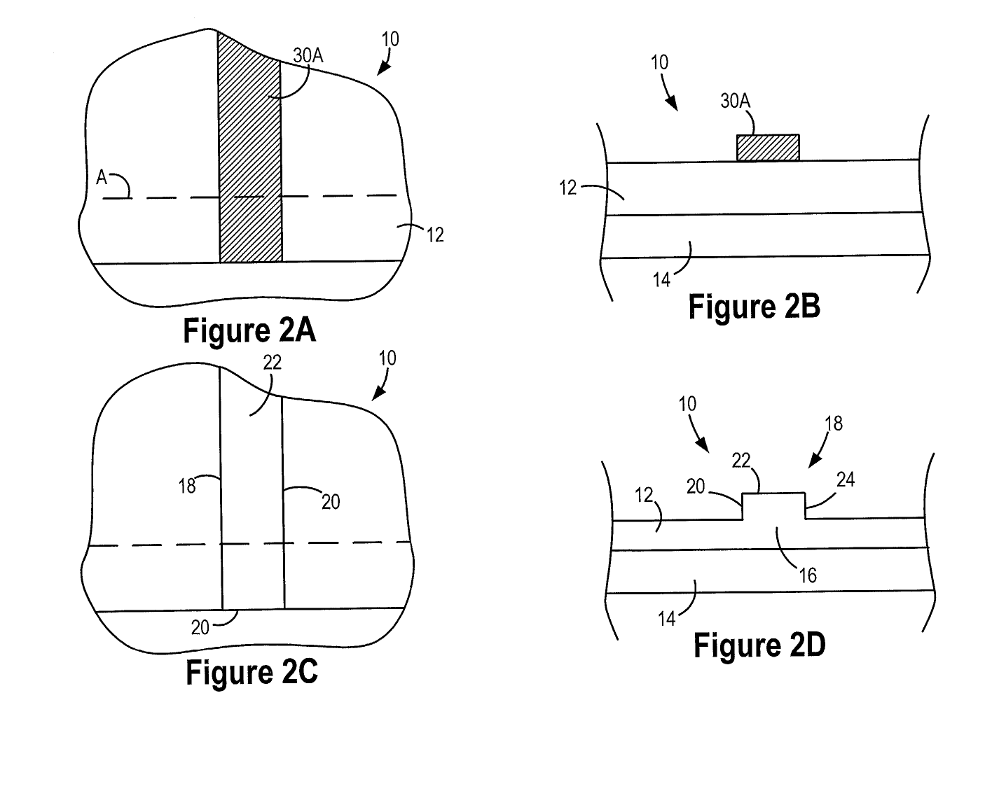

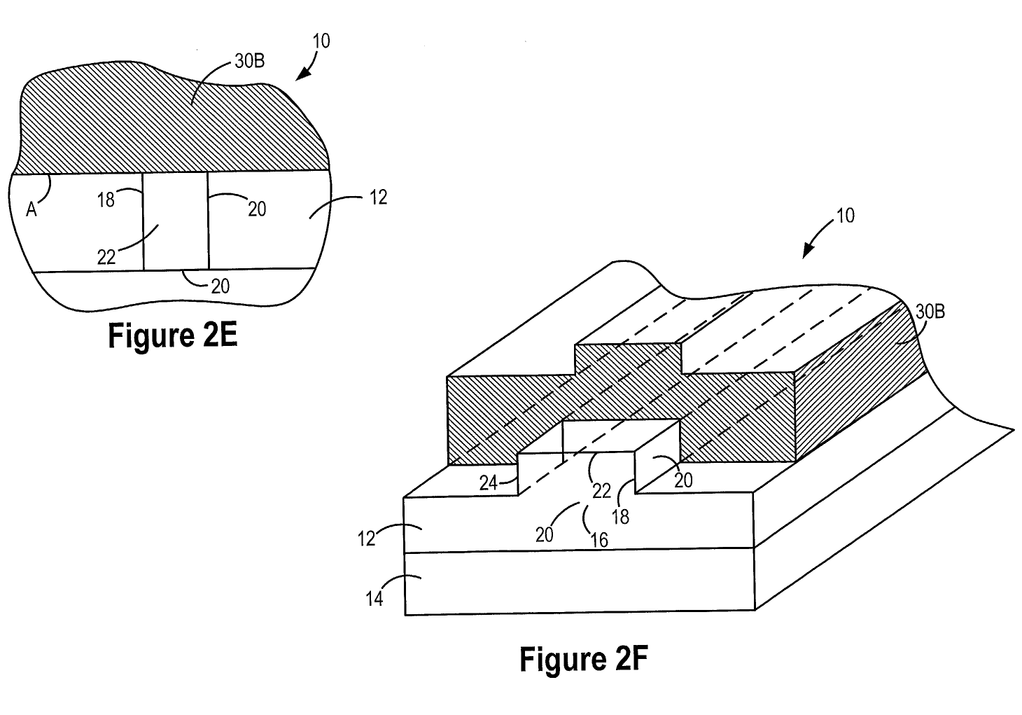

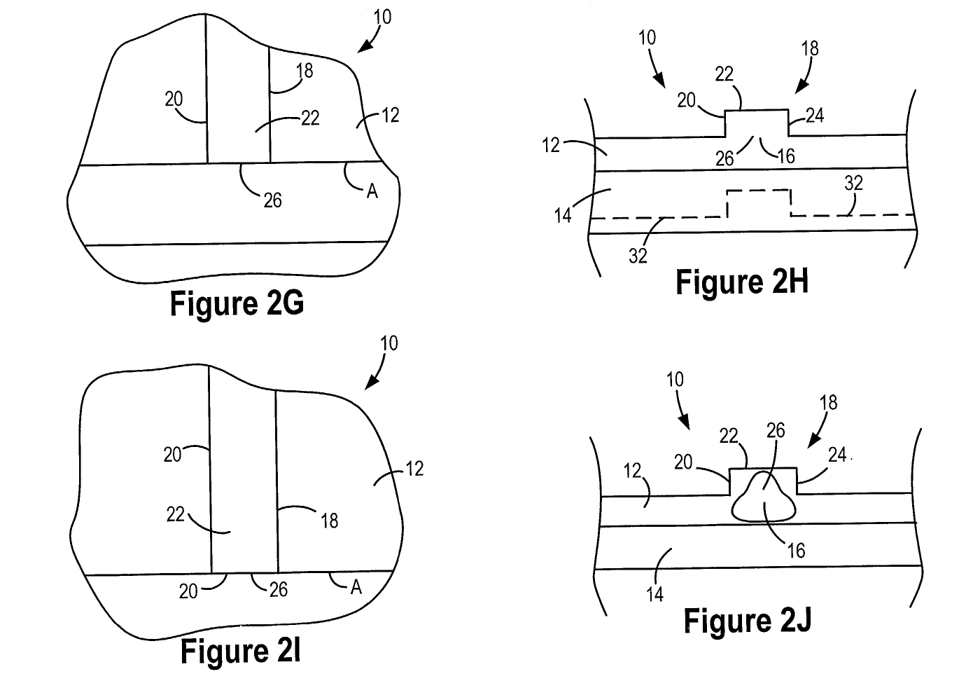

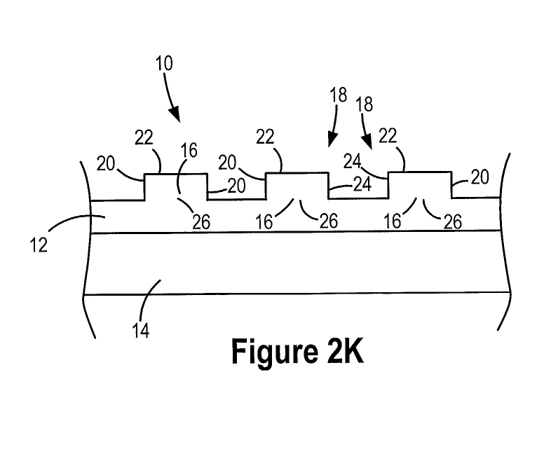

FIG. 2A through FIG. 2J illustrate a method of forming an optical component 10 having a waveguide with sidewalls 24 and a waveguide facet 26. Each Figure shows only a portion of the optical component 10. FIG. 2A is a topview of the optical component 10 and FIG. 2B is a side view of the optical component 10 taken at the dashed line on FIG. 2A. The dashed line denotes the location where the waveguide facet 26 is to be formed. The optical component 10 includes a light transmitting medium 12 positioned over a base 14. A first mask 30A is formed over the region(s) of the optical component 10 where the ridge 18 of one or more waveguides is to be formed. For the purposes of illustration, formation of a single waveguide is discussed. The waveguide is initially to be formed past the location where the facet is to be formed.

A first etch is performed and the first mask 30A removed to provide the optical component 10 illustrated in FIG. 2C and FIG. 2D. FIG. 2C is a top view of the optical component 10 and FIG. 2D is a cross section of the optical component 10 taken at the dashed line in FIG. 2C. The first etch results in formation of the sidewalls 24 of the ridge 18.

A second mask 30B is formed on the optical component 10 to provide the optical component 10 illustrated in FIG. 2E and FIG. 2F. FIG. 2E is topview of a portion of the optical component 10 and FIG. 2F is a perspective view of a portion of the optical component 10. An edge of the second mask 30B extends across the ridge 18 and is aligned with the location where the waveguide facet 26 is to be formed.

A second etch is performed part way through the optical component 10 and the second mask 30B removed to provide the optical component 10 shown in FIG. 2G and FIG. 2H. FIG. 2G is a topview of the optical component 10 and FIG. 2H is a cross section of the optical component 10 taken at the line labeled A in FIG. 2G. When the second etch is performed part way through the optical component 10, an etch bottom 32 is formed in the optical component 10. For the purposes of illustration, the etch bottom 32 is illustrated by the dashed line in FIG. 2H. The second etch forms the waveguide facet 26.

A portion of the base 14 can be removed to provide the optical component 10 shown in FIG. 2I and FIG. 2J. FIG. 2I is a topview of the optical component 10 and FIG. 2J is a cross section of the optical component 10 taken at the line labeled A in FIG. 2I. The optical component 10 of FIGS. 2I and 2J can also be generated by performing the second etch the way through the optical component 10 instead of part way through the optical component 10.

When FIG. 2I and FIG. 2J is generated by removing a portion of the base 14, the base 14 is removed from the bottom of the base 14 moving toward the etch bottom 32. In some instances the base 14 is removed all the way up to the highest point of the etch bottom 32. Alternatively, a smaller amount of the base 14 or none of the base 14 is removed and the remaining portion of the base 14 can be cracked, cleaved or cut. Suitable methods for removing the base 14 include, but are not limited to, polishing, milling or etching the bottom of the optical component 10. Further, the substrate can be selectively removed by forming a second groove into the bottom of the base 14 opposite the groove formed by the second etch. Additionally, the optical component 10 can be cut through the bottom of the base 14 to the etch bottom 32.

A cladding layer 28 can optionally be formed over the light transmitting medium 12 shown in FIG. 2J. When the light transmitting medium 12 is silicon, a silica cladding layer 28 can be formed by exposing the silicon to air at ambient conditions or by a thermal oxide treatment.

Although the method shown in FIG. 2A through FIG. 2J illustrate formation of an optical component 10 having a single waveguide, the method can be adapted to formation of an optical component 10 having a plurality of waveguides. FIG. 2K shows a cross section of an optical component 10 having a plurality of waveguides. The first and/or second etch can be performed so as to concurrently form one or more surfaces 20 on more than one of the waveguide.

The sidewalls 24 of the ridge 18 are formed as a result of the first etch. The waveguide facet 26 is formed as a result of the second etch. As noted above, these surfaces 20 are preferably smooth in order to reduce scattering of light signals. The mask employed during the etch is the largely the source of the vertical surface smoothness. A suitable mask includes, but is not limited to, an oxide mask.

The etch is largely the source of the horizontal surface smoothness. An etch that can provide the surfaces 20 with the desired level of horizontal smoothness includes placing the optical component 10 in an etching chamber and applying an etching medium to the optical component 10. The etching medium includes a fluorine containing gas and one or more partial passivants. The fluorine containing gas serves as an etchant. Suitable fluorine containing gases include, but are not limited to, SF₆, Si₂F₆ and NF₃. A partial passivant can have both etchant and passivant characteristics depending on the conditions under which the etching medium is applied. A passivant is a medium that causes formation of a protective layer during the etch. The protective layer protects the optical component 10 from the etchant. A suitable protective layer is a polymer layer. Suitable partial passivants include, but are not limited to, HBr, C₄F₈, SiF₄ or CHₓF_{y} such as CH₂F₂, or CHF₃. When the light transmitting medium 12 is Si, HBr can act as a passivant by reacting with the Si to form a protective layer of SiBr and CHF₃ can act as a passivant by reacting with the Si to form a protective layer of SiF. The choice of partial passivant can be a function of the application. For instance, HBr is a suitable partial passivant for many applications but can be a source of micro-masking when HBr is employed to etch large areas Because CHF₃ is not associated with micro-masking when applied over large areas, CHF₃ may serve as the partial passivant when large areas are etched.

An etching medium that has been shown to provide a high level of smoothness includes SF₆ as the fluorine containing gas and CHF₃ as the partial passivant. Another etching medium that has been shown to provide a high level of smoothness includes SF₆ as the fluorine containing gas and HBr as the partial passivant. Another etching medium that has been shown to provide a high level of smoothness includes SF₆ as the fluorine containing gas and HBr as the partial passivant.ccc.

When the light transmitting medium 12 is silicon, suitable smoothness can be achieved when the etching medium has a molar ratio of partial passivant to fluorine containing gas in the range of 0.1:1 to 100:1, 0.5:1 to 50:1, 0.5:1 to 10:1, 0.5:1 to 5:1 or 1:1 to 2:1. Higher partial passivant ratios can provide increased levels of smoothness because the protection of the light transmitting medium is increased. However, the etching rate slows as the ratio increases. Accordingly, the advantages of the increased smoothness should be balanced against the increased manufacturing time.

In some instances, the etching medium is applied at a chamber pressure of 1 mTorr to 600 mTorr, 1 mTorr to 200 mTorr, 1 mTorr to 60 mTorr, 1 mTorr to 30 mTorr or 10 mTorr to 20 mTorr. When the etching medium is applied in a directional etch, lower pressures can increase the degree of smoothness achieved by the etch because the lower pressure allows for a higher degree of directionality. Suitable chamber, or cathode, temperatures during application of the etching medium include, but are not limited to, 10° C. to 50° C.

A suitable etch for applying the etching medium includes, but is not limited to, an inductively coupled reactive ion etch (RIE), a capacitively coupled RIE, a magnetically field enhanced RIE (MERIE), a helicon plasma RIE, electron cyclotron resonance (ECR) plasma RIE and other high density plasma etches. The etch selection can influence the action of the partial passivant. For instance, an inductively coupled plasma etch produces a lower ion energy than results from a capacitively coupled reactive ion etch. The reduced ion energy can cause a partial passivant such as HBr to acts as a passivant while in a capacitively coupled reactive ion etch the HBr would act as an etchant.

Other components can be added to the etching medium to improve the performance of the etching medium. In some instances, the etching medium includes oxygen. The oxygen can acts as a passivant that serves to form a protective layer on the optical component 10 during the etch. When the light transmitting medium 12 is silicon and the etching medium includes oxygen, examples of the molar ratio of fluorine containing gas to oxygen include, but are not limited to, ratios in the range of 0.1 to 10 or 0.2 to 5.

The presence of oxygen in the etching medium can result in etching of the mask. For instance, the oxygen can cause etching of a photoresist mask. The rate at which the photoresist is etched increases as the amount of oxygen increases. The mask etch rate can become very fast at high oxygen concentrations. As a result, the etching medium does not include oxygen in some instances. Examples of an etching medium that can provide the desired level of smoothness without oxygen include, SF₆ and CHF₃ or SF₆ and C₄F₈.

An example of other components that can be added to the etching medium include Si₂F₆ and/or SiF₄. In one example, the etching medium includes SF₆ as the fluorine containing gas, CHF₃ as the partial passivant, Oxygen as the passivant and SiF₄. When an oxide mask is employed during application of the etching medium, the SiF₄ can increase the selectivity of the etching medium for the light transmitting medium 12 over the mask. More specifically, the Si from the SiF₄ can reacts with the Oxygen to form SiO₂ on the oxide mask.

Another component that can be added to the etching medium is a noble gas such as Ar, He and Xe. The noble gas can serve to enhance ion bombardment and improve etch uniformity across the wafer.

### EXAMPLE 1

The following example is performed on a Decoupled Plasma Source Deep Trench etcher (DPSDT) manufactured by Applied Materials. An optical component 10 is positioned in the chamber. The optical component 10 includes silicon as the light transmitting medium 12. One or more portions of the optical component 10 are masked with an oxide mask. The optical component 10 is etched by delivering an etching medium having SF₆ as the fluorine containing gas, HBr as the partial passivant and Oxygen. The SF₆ flow rate is about 40 sccm, the HBr flow rate is about 240 sccm and the Oxygen flow rate is 36 sccm so as to maintain the chamber pressure at about 10 mTorr. The coil is operated at 1000 W and 13.56 MHz. The cathode is operated at 50 W and 400 KHz and at a temperature of about 10° C. to 20° C. The etch results in the formation of a surface 20 on the optical component 10. The etch is performed for a period of time need to form the surface 20 to the desired height. Performing an etch under these conditions can produce a horizontal smoothness on the order of 7 nm.

### EXAMPLE 2

The following example is performed on a Decoupled Plasma Source Deep Trench etcher (DPSDT) manufactured by Applied Materials. An optical component 10 is positioned in the chamber. The optical component 10 includes silicon as the light transmitting medium 12. One or more portions of the optical component 10 are masked with an oxide mask. The optical component 10 is etched by delivering an etching medium having SF₆ as the fluorine containing gas, CHF₃ as the partial passivant and Oxygen. The SF₆ flow rate is about 30 sccm, the CHF₃ flow rate is about 60 sccm and the Oxygen flow rate is 70 sccm so as to maintain the chamber pressure at about 15 mTorr. The coil is operated at 1000 W and 13.56 MHz. The cathode is operated at 25 W and 400 KHz and at a temperature of about 10° C. to 20° C. The etch results in the formation of a surface 20 on the optical component 10. The etch is performed for a period of time need to form the surface 20 to the desired height. Performing an etch under these conditions can produce a horizontal smoothness on the order of 7 nm.

### EXAMPLE 3

The following example is performed on a Decoupled Plasma Source Deep Trench etcher (DPSDT) manufactured by Applied Materials. An optical component 10 is positioned in the chamber. The optical component 10 includes silicon as the light transmitting medium 12. One or more portions of the optical component 10 are masked with an oxide mask although the mask can be a photoresist. The optical component 10 is etched by delivering an etching medium having SF₆ as the fluorine containing gas, C₄F₈ as the partial passivant. The SF₆ flow rate is about 30 sccm, the C₄F₈ flow rate is about 60 sccm so as to maintain the chamber pressure at about 15 mTorr. The coil is operated at 1000 W and 13.56 MHz. The cathode is operated at 25 W and 400 KHz and at a temperature of about 10° C. to 20° C. The etch results in the formation of a surface 20 on the optical component 10. The etch is performed for a period of time need to form the surface 20 to the desired height. Performing an etch under these conditions can produce a horizontal smoothness on the order of 7 nm.

The example of FIG. 2A through FIG. 2J shows different surfaces 20 of the optical component 10 formed with different etches. For instance, the waveguide sidewalls 24 were formed during the first etch and the waveguide facet 26 was formed during the second etch. When different surfaces 20 are formed with different etches, the etching medium need not be the same during different etches. Additionally, every etch need not include an etching medium according to the present invention.

The method disclosed in FIG. 2A through FIG. 2J are shown for the purposes of illustrating an example of a method of forming an optical component. The same optical components can be formed using a variety of different methods. When these methods employ an etch to form a surface on the component, the etches according to the present invention can be employed to form these components. Additionally, the etches can be employed to form surfaces other than facets and sidewalls. For instance, the etches can be employed to form a reflecting surface 29 such as the reflecting surface 29 shown in FIG. 1E. A suitable method for forming a reflecting surface 29 is taught in U.S. patent application Ser. No. 09/723,757, filed on Nov. 28, 2000, entitled “Formation of a Reflecting Surface on an Optical Component” and incorporated herein in its entirety.

Much of the above discussion discloses placing a single optical component 10 in a chamber and/or applying the etching medium to a single optical component 10. However, the etching medium can be concurrently applied to a plurality of optical components 10 positioned in a chamber. The plurality of optical components 10 can be independent of one another or can be integrated on the same device. For instance, a plurality of optical components 10 are often positioned on a single wafer. The etching medium can be applied to all or a portion of the optical components 10 on the wafer.

Although the etching medium is disclosed in the context of forming a surface 20 of a ridge 18 waveguide, the etching medium can be employed to form surfaces 20 on other waveguides. Examples of other waveguides having surfaces 20 that can be formed with the etching medium include, but are not limited to, channel waveguides, buried channel waveguides,

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

I claim:

1. A method of forming an optical component, comprising:
forming a mask over a light transmitting medium so as to protect a region of the light transmitting region where a waveguide is to be formed; and
applying an etching medium to the light transmitting medium so as to form one or more surfaces of the waveguide, the etching medium including a fluorine containing gas and one or more partial passivants.

2. The method of claim 1, wherein the fluorine containing gas includes SF₆ and the partial passivant includes CHF₃.

3. The method of claim 1, wherein the fluorine containing gas includes SF₆ and the partial passivant includes C₄F₈.

4. The method of claim 1, where the etching medium excludes oxygen.

5. The method of claim 1, wherein the fluorine containing gas is selected from a group consisting of SF₆, Si₂F₆ and NF₃.

6. The method of claim 1, wherein the partial passivant is selected from a group consisting of HBr, SiF₄, C₄F₈, CH₂F₂ and CHF₃.

7. The method of claim 1, wherein the one or more surfaces includes a sidewall of the waveguide.

8. The method of claim 1, wherein the one or more surfaces include a waveguide facet.

9. The method of claim 1, wherein the etching medium is applied at a pressure of 1 mTorr to 600 mTorr.

10. The method of claim 1, wherein the etching medium is applied at a pressure of 1 mTorr to 60 mTorr.

11. The method of claim 1, wherein the etching medium is applied at a pressure of 10 mTorr to 30 mTorr.

12. The method of claim 1, wherein the etching medium includes one or more other media.

13. The method of claim 1, wherein the one or more other media is selected from the group consisting of SiF₄ and SiF₆

14. The method of claim 1, wherein the one or more other media include a noble gas.

15. The method of claim 1, wherein the etching medium has a molar ratio of partial passivant to fluorine containing gas of 0.1:1 to 100:1.

16. The method of claim 1, wherein the etching medium has a molar ratio of partial passivant to fluorine containing gas of 0.5:1 to 10:1.

17. The method of claim 1, wherein the etching medium has a molar ratio of partial passivant to fluorine containing gas of 1:1 to 2:1.

18. The method of claim 1, wherein the mask is formed so as to protect a region of the light transmitting region where a plurality of waveguides are to be formed and the etching medium is applied to as to form one or more surfaces on at least one of the waveguides.

19. The method of claim 1, wherein the mask is an oxide mask.

20. The method of claim 1, wherein the mask is a photoresist.

21. The method of claim 1, wherein the etching medium is applied in an inductively coupled plasma etch.

22. A method of forming an optical component, comprising:
obtaining an optical component having a light transmitting medium positioned over a base; and
applying an etching medium to the light transmitting medium so as to form at least one surface of a waveguide in the light transmitting medium, the etching medium including a fluorine containing gas and one or more partial passivants.

23. The method of claim 22, wherein the fluorine containing gas includes SF₆ and the partial passivant includes CHF₃.

24. The method of claim 22, wherein the fluorine containing gas includes SF₆ and the partial passivant includes C₄F₈.

25. The method of claim 22, where the etching medium excludes oxygen.

26. The method of claim 22, wherein the fluorine containing gas is selected from a group consisting of SF₆, CF₄, Si₂F₆ and NF₃.

27. The method of claim 22, wherein the partial passivant is selected from a group consisting of HBr, SiF₄, C₄F₈, CH₂F₂ and CHF₃.

28. The method of claim 22, wherein obtaining the optical component includes receiving the optical component from a supplier.

29. The method of claim 22, wherein the etching medium is applied at a pressure of 1 mTorr to 200 mTorr.

30. The method of claim 22, wherein the etching medium is applied at a pressure of, 5 mTorr to 60 mTorr.

31. The method of claim 22, wherein the etching medium includes a second fluorine containing gas selected from the group consisting of SiF₄ and SiF₆.

32. The method of claim 22, wherein the etching medium also includes a noble gas.

33. The method of claim 22, wherein the etching medium has a molar ratio of partial passivant to fluorine containing gas less than 100:1.

34. The method of claim 22, wherein the etching medium has a molar ratio of partial passivant to fluorine containing gas of about 0.5:1 to 10:1.

35. The method of claim 22, wherein the etching medium has a molar ratio of partial passivant to fluorine containing gas of about 1:1 to 2:1.

36. The method of claim 22, wherein the mask is formed so as to protect a region of the light transmitting region where a plurality of waveguides are to be formed and the etching medium is applied to as to form one or more surfaces on at least one of the waveguides.

37. The method of claim 22, wherein the etching medium is applied so as to form at least one surface on a plurality of waveguides.

38. The method of claim 22, wherein the etching medium consists of only SF6 as the fluorine containing gas, CHF₃ as the partial passivant and Oxygen.

39. The method of claim 22, wherein the etching medium is applied in an inductively coupled plasma etch.
